(19) United States
(12) Patent Application Publication
(10) Pub. No.: US 2022/0307939 A1
(43) Pub. Date: Sep. 29, 2022

(54) GLAZING SENSOR

(71) Applicant: AGC GLASS EUROPE, Louvain-la-Neuve (BE)

(72) Inventors: Maxime COLLIGNON, Gottignies (BE); Arnaud ISERENTANT, Vieux-Genappe (BE); Patrick AYOUB, Louvain-La-Neuve (BE)

(73) Assignee: AGC GLASS EUROPE, Louvain-la-Neuve (BE)

(21) Appl. No.: 17/627,465

(22) PCT Filed: Jul. 16, 2020
(86) PCT No.: PCT/EP2020/070089

§ 371 Date: Jan. 14, 2022

(30) Foreign Application Priority Data
Jul. 19, 2019 (EP) 19187269.6

(51) Int. Cl. G01M 5/00

(52) U.S. Cl. CPC G01M 5/0066

(57) ABSTRACT

A glazing sensor for detecting vibration of an automotive glazing. The glazing sensor includes at least one vibration sensor and a communication module. The vibration sensor converts a vibration of the glass into an electrical signal and the communication module transmits a signal of characteristic information of the electrical signal. The glazing sensor further includes an acceleration sensor. The glazing sensor puts itself in sleep mode when no acceleration is detected during a predetermined period of time, and puts itself in active mode when an acceleration is detected, with the functionality of the glazing sensor in sleep mode is reduced compared to the functionality in active mode.

### FIELD OF THE INVENTION

The invention relates to the field of glazing sensors. More specifically it relates to a glazing sensor which is adapted for detecting vibration of on the glazing of a vehicle which is caused by an external event affecting the glazing such as an impact on the glazing.

### BACKGROUND OF THE INVENTION

Nowadays there is a need for glazing sensors (see for example WO2019101884) which are able to estimate the effect of an external event affecting the glazing such as an impact on the glazing. Such an impact may result in a defect of the glazing which can be repaired or it may result in a defect of the glazing which requires replacement of the glazing.

In both cases it is important that the person who is responsible for the maintenance of the glazing is aware about the consequence of the impact and can derive therefrom which measures should be taken. There is therefore a need for sensors which are able to communicate characteristic information of the impact which allows to determine which measures should be taken to repair the glazing after the impact. This information is preferably communicated in an automated way.

Glazing sensors preferably are autonomous in terms of power. They preferably do not need any wiring from the vehicle for powering the sensor. Advantageously the sensors can be easily installed independent of the vehicle type and they can be easily moved from a broken glazing to a new glazing. In order to achieve a long lifetime the power consumption of a glazing sensor should therefore preferably small.

There is therefore a need for glazing sensors for detecting glass vibration which have a reduced power consumption.

### SUMMARY OF THE INVENTION

It is an object of embodiments of the present invention to provide a good glazing sensor for detecting vibration of an automotive glazing and to provide automotive glazing comprising such a glazing sensor. It is an advantage of embodiments of the present invention that the power consumption of the glazing sensor is controlled.

The above objective is accomplished by a method and device according to the present invention.

In a first aspect embodiments of the present invention relate to a glazing sensor for detecting vibration of an automotive glazing. The glazing sensor comprises at least one vibration sensor, and a communication module. The vibration sensor is adapted for converting a vibration of the glass into an electrical signal and the communication module is adapted for transmitting a signal comprising characteristic information of the electrical signal. The glazing sensor, moreover, comprises an acceleration sensor. The glazing sensor is adapted for putting itself in sleep mode when no acceleration is detected during a predetermined period of time, and for putting itself in active mode when an acceleration is detected, wherein in sleep mode the functionality of the glazing sensor is reduced compared to the functionality in active mode.

It is an advantage that a glass vibration can be measured using a glazing sensor in accordance with embodiments of the present invention. The vibration sensor generates an electrical signal which is a measure for the glass vibration. Characteristic information of the electrical signal is transmitted by the communication module. This obtained characteristic information may be the electrical signal itself, or it may be the filtered electrical signal, and/or digitized electrical signal, and/or a processed electrical signal. This characteristic information of the electrical signal allows to determine the effect an external event has had on the glazing. This external event may for example be the impact of an object on the glazing or the friction of a worn glazing wiper. Based on this characteristic information of the electrical signal it may for example be possible to determine between a breakage/non breakage situation.

It is an advantage of embodiments of the present invention that in sleep mode the functionality of the glazing sensor is reduced compared to the functionality in active mode. This will result in a reduced power consumption of the glazing sensor in sleep mode compared to the power consumption of the glazing sensor in active mode. In embodiments of the present invention the glazing sensor may be adapted such that in sleep mode no signal is transmitted.

It is found by the inventors that, even if the vehicle is moving at a constant speed, changes in the direction of the vehicle, or accelerations due to an uneven support area (this may for example be the road surface for a car, truck or bus; the rail surface for a train), will result in an acceleration of the glazing sensor. Hence, it is possible to determine whether the vehicle is moving or not from the signal of the acceleration sensor. If the vehicle is not moving, the power consumption of the glazing sensor can be reduced because at least part of its functionality is not required.

In embodiments of the present invention the glazing sensor is adapted for reading out the acceleration sensor at regular intervals and for putting the glazing sensor in sleep mode if no acceleration is detected during a predetermined number of intervals.

It is an advantage of embodiments of the present invention that only at periodic intervals the acceleration sensor is checked. Thus, the power consumption can be reduced even more. The time between the regular intervals times the predetermined number of timestamps thereby corresponds with the predetermined period of time.

In embodiments of the present invention the glazing sensor is adapted for receiving an interrupt from the acceleration sensor for detecting an acceleration.

It is an advantage of embodiments of the present invention that an interrupt is generated for putting itself in active mode. Thus, a glazing sensor can be obtained which is in active mode after being interrupted and which is in sleep mode if no interrupt was generated during a predefined period of time.

In embodiments of the present invention the glazing sensor is adapted for managing the power consumption of at least one electronic component of the glazing sensor.

The glazing sensor may for example be adapted for controlling the power consumption of the communication module and/or of the vibration sensor.

In embodiments of the present invention the power consumption of the glazing sensor may for example be controlled by switching off part of the sensor. For example, the communication module and/or the vibration sensor may be partly or completely switched off. This functionality is not required when the vehicle is not moving and hence can be switched off or the functionality thereof can be reduced, resulting in a reduced power consumption.

In embodiments of the present invention the vibration sensor is a piezoelectric sensor.

It is an advantage of embodiments of the present invention that a passive vibration sensor is used as this provides an easy way to convert the mechanical vibration into an electrical signal.

In embodiments of the present invention the glazing sensor may comprise an analog to digital converter for converting the electrical signal from the vibration sensor into a digital signal.

In embodiments of the present invention the glazing sensor moreover comprises a processing module adapted for processing the digital signal before transmitting the processed signal with the communication module.

The processing module may for example be a microcontroller, a microprocessor, a field programmable gate array.

It is an advantage of embodiments of the present invention that the bandwidth of the communication module may be reduced as less data needs to be transmitted because of the preprocessing of the digital signal by the processing module of the glazing sensor.

In embodiments of the present invention the glazing sensor may be put in reduced power mode by switching the processing module to a reduced power mode. This may be one of the modules of the one or more modules which are put in reduced power mode.

In embodiments of the present invention the processing module is adapted for comparing a predefined signature with the digital signal or wherein the processing module may use a machine learning model for obtaining characteristic information of the electrical signal.

In embodiments of the present invention the machine learning model may be obtained using a machine learning algorithm.

In embodiments of the present invention the processing module is adapted for determining the characteristic information by using an analytical algorithm. The digital signal may be compared with a predetermined signature. This may for example be a threshold for determining the severity of the external event. Another signature may for example be the shape of the digital signal which is induced by a breaking glass.

In embodiments of the present invention the glazing sensor may comprise at least two vibration sensors.

It is an advantage of embodiments of the present invention that 2 electrical signals are obtained. One for each vibration sensor. Thus, a redundant electrical signal may be obtained.

In embodiments of the present invention the vibration sensors may be at different locations. It is an advantage of these embodiments that it is possible to estimate the location of the external event on the glazing. This is enabled for glazing sensors which are comprising at least two vibration sensors at different locations because the signal difference between both sensors is an indication for the position of the external event. In some embodiments of the present invention one of the two signals from the two vibration sensors may provide redundancy.

In embodiments of the present invention the communication module is adapted for wirelessly transmitting a signal comprising the characteristic information of the electrical signal.

It is an advantage of embodiments of the present invention that the glazing sensor is a standalone sensor which does not require any wiring.

In a second aspect embodiments of the present invention relate to a glazing package which comprises a glazing sensor according to embodiments of the present invention. The glazing package moreover comprises a gateway which is adapted for receiving the characteristic information of the electrical signal from the communication module and for relaying the received characteristic information.

In a third aspect embodiments of the present invention relate to a glazing system which comprises a glazing package according to embodiments of the present invention. The glazing package moreover comprises a computing device which is adapted for receiving the relayed characteristic information of the electrical signal and for storing and processing the received characteristic information of the electrical signal.

In a fourth aspect embodiments of the present invention relate to an automotive glazing which comprises the glazing and at least one glazing sensor according to embodiments of the present invention. The at least one glazing sensor is mounted at a border of the automotive glazing.

It is an advantage of embodiments of the present invention that the glazing sensor is mounted at a border of the automotive glazing. This implies that it is outside the field of view of the driver.

In embodiments of the present invention the automotive glazing is mounted in a vehicle, wherein at least one glazing sensor is mounted on the glazing at the inside of the vehicle.

It is an advantage of embodiments of the present invention that the glazing sensor is protected against rain and wind.

In embodiments of the present invention the automotive glazing is mounted in a vehicle and at least one glazing sensor is mounted on the glazing at the outside of the vehicle under a hood of the vehicle.

It is an advantage of embodiments of the present invention that the glazing sensor is protected against direct impact of rain and wind while still being mounted against the outside of the glazing. Being mounted on the outside of the glazing has as particular advantage that the vibrations sensed by the outside sensor are less damped than the vibrations sensed by the inside sensor.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 schematically shows the basic building blocks of a glazing sensor in accordance with embodiments of the present invention.

FIG. 2 schematically shows a schematic drawing of a glazing package and a glazing system according to embodiments of the present invention.

FIG. 3 schematically shows a glazing sensor in accordance with embodiments of the present invention which comprises additional building blocks compared to FIG. 1.

FIG. 4 shows a schematic drawing of a glazing sensor in accordance with embodiments of the present invention.

FIG. 5 shows a schematic drawing of the bottom view of a glazing sensor in accordance with embodiments of the present invention.

FIG. 6 shows different configurations of automotive glazing in accordance with embodiments of the present invention.

Any reference signs in the claims shall not be construed as limiting the scope. In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

In a first aspect embodiments of the present invention relate to a glazing sensor 100 for detecting vibration of an automotive glazing. This may for example be a windscreen sensor. The glazing sensor 100 comprises at least one vibration sensor 110, and a communication module 120.

The vibration sensor 110 is adapted for converting a vibration of the glass into an electrical signal and the communication module 120 is adapted for transmitting a signal comprising characteristic information of the electrical signal. Characteristic information of the electrical signal may for example be the electrical signal itself, the digitized electrical signal, the filtered electrical signal in the digital or analog domain, the amplified electrical signal, the Fast Fourier Transform (FFT) of the digitized electrical signal, the analyzed electrical signal of which the result may for example indicate the breaking/non-breaking of the glass. The glazing sensor may be adapted for executing steps for obtaining characteristic information of the electrical signal before transmitting the characteristic information. It may therefore for example comprise a processing unit.

The glazing sensor 100 moreover comprises an acceleration sensor 130. Different types of acceleration sensors may be used. The acceleration sensor may for example be adapted for measuring in one, two or three directions. In some embodiments of the present invention a gyroscope may be used as acceleration sensor. Such a gyroscope may for example enable measuring rotative accelerations by measuring angular velocity.

The glazing sensor 100 is adapted for putting itself in sleep mode when no acceleration is detected during a predetermined period of time, and for putting itself in active mode when an acceleration is detected. In sleep mode the functionality of the glazing sensor is reduced compared to the functionality in active mode and vice versa. This results in a reduced power consumption of the glazing sensor 100 in sleep mode compared to the power consumption in active mode, and in an increased power consumption in active mode compared to the power consumption in sleep mode.

In embodiments of the present invention the glazing sensor may be put in sleep mode if during a plurality of periods no acceleration was detected. The glazing system may be adapted for reading out the acceleration sensor 130 at regular intervals and for putting the glazing sensor in sleep mode if no acceleration is detected during a predetermined number of intervals. In some embodiments an interrupt may be generated upon detection of the acceleration. In case no interrupt is received during the predefined period of time the glazing sensor is put in sleep mode. Upon reception of an interrupt or a sequence of interrupts, the glazing sensor is put in active mode.

According to an embodiment of the present invention, the detection of acceleration by the method of reading out the acceleration sensor and the detection of acceleration by the interrupt from the acceleration sensor may be combined.

The power consumption of different components may be managed by the glazing sensor. For example the power consumption of the communication module may be managed by the glazing sensor. The communication module may for example use Bluetooth Low Energy (BLE) as radio technology to communicate with other devices.

The communication module may allow the glazing sensor to communicate directly with a server/cloud infrastructure, for instance by using the cellular network. As stated above, the communication module may use short range communication technology such as Bluetooth Low Energy. In this case, the glazing sensor needs another device to relay its messages to the server/cloud infrastructure. This additional device is named gateway 210 throughout this document. It features one or more communication modules allowing, on one hand, for short range communications with the glazing sensor (for instance through BLE) and, on the other hand, for long range communications with a server/cloud infrastructure (for instance through cellular communication).

The gateway 210 may be powered by the vehicle (in case of a car such a device may be connected to the on-board diagnostics (OBD) port, on a cigarette lighter adapter or a USB port). The gateway will most likely not be powered when the vehicle is turned off (these ports are generally powered only when the vehicle is turned on). This means that, if the car is not turned on, the glazing sensor 100 cannot communicate with the gateway. In a preferred embodiment, the glazing sensor 100 is autonomous in terms of power supply and communicates using wireless technology. It can therefore not detect whether the vehicle is turned on or off. Through the acceleration sensor 130, it could however detect whether the car is moving and use this piece of information a hint that the car is turned on and that the gateway may be powered on.

The gateway 210 may also be implemented through an application on the smartphone of the driver. If the driver is not present in the car, the glazing sensor 100 cannot communicate with the gateway. Again, the glazing sensor 100 is not able to detect directly whether the driver is present. However, it can again rely on information from the acceleration sensor 130 to detect that the car is moving and that the driver is certainly present and that a gateway be available for communication.

It can be deduced from the above that, as a simple rule, the glazing sensor 100 may disable its communication module (e.g. the BLE advertisement), the glazing sensor 100 may turn off or put into sleep or low power modes its communication module (e.g. Bluetooth module) when the vehicle is not moving.

The communication module consumes energy. It is therefore important to limit its energy consumption as much as possible and, in particular, when there's a high chance that no gateway 210 is available for communication in the surroundings, either because it is not present or not powered.

In embodiments of the present invention the glazing sensor is equipped with an accelerometer allowing it to determine whether the vehicle, wherein the glazing sensor is located, is moving. It is thereby assumed that when the car is moving, it is turned on and a gateway device 210 is nearby for receiving the signal from the communication module. This piece of information is, therefore, used by the glazing sensor as a hint on the potential availability of a gateway device to communicate with. Once the accelerometer detects a move, the glazing sensor is set into active mode, assuming that this move results from the vehicle being turned on. In some embodiments of the present invention the glazing sensor thereby assumes that a gateway may be available for communication. Thus, in some embodiments of the present invention the glazing sensor will, in case of an external event affecting the glazing, enable its communication module for communication if it assumes that the gateway is present and available for communication.

In embodiments of the present invention the glazing sensor 100 may periodically check whether the car keeps on moving by verifying the output of the acceleration sensor 130. In embodiments of the present invention the glazing sensor may be adapted such that after no acceleration is detected several times in a row, the glazing sensor assumes the vehicle is not moving anymore, and the glazing sensor is put in sleep mode. In sleep mode at least some of the functionality of the glazing sensor is reduced. This may for example be achieved by not enabling the communication module, in case of an external event affecting the glazing, when the glazing sensor is in sleep mode. Thereby unnecessarily turning on the communication module is avoided.

In embodiments of the present invention the glazing sensor is adapted for managing the power consumption of at least one electronic component of the glazing sensor. The acceleration sensor 130 allows the glazing sensor 100 to intelligently manage the lifecycle of its communication module and, in general, to manage its power. This behavior is not limited to one communication module. It can be extended to other communication modules if there are additional communication modules present. It some embodiments it may also be used to adapt the lifecycle of the microcontroller itself by changing, for example, the frequency of its periodic wake up. A glazing system in accordance with embodiments of the present invention may be powered by a cable from the car battery.

In an alternative embodiment an external interface may be present which allows to connect a state of the art power cable. The interface may for example be mounted on a PCB of the glazing sensor. The interface may for example be a micro-USB port allowing to connect a state of the art power cable to be connected to the PCB.

Such cables need not necessarily be connected to the car battery but may instead be connected to a USB port in the car or to a cigarette lighter adapter providing one or more USB ports.

In a preferred embodiment, energy harvesting techniques are used to power the glazing sensor. Hence, an autonomous glazing sensor can be obtained. It is an advantage of embodiments of the present invention that energy consumption can be reduced to minimum values particularly in sleep mode. In that case, power consumption can for example be as low as 1 mW, even below 100 μW. A small solar cell and a battery can be used to avoid any cabling to the sensor. In a preferred embodiment the glazing sensor comprises a solar cell and one or more supercapacitors. In a particular embodiment, a combination of two supercapacitors is used:
A small supercapacitor which charges fast and makes the system available, when completely discharged, within a few minutes (typically less than 5 minutes) after light is received again on the photovoltaic cells;
A bigger supercapacitor that charges slowly but instead offers large capacity and longer autonomy.

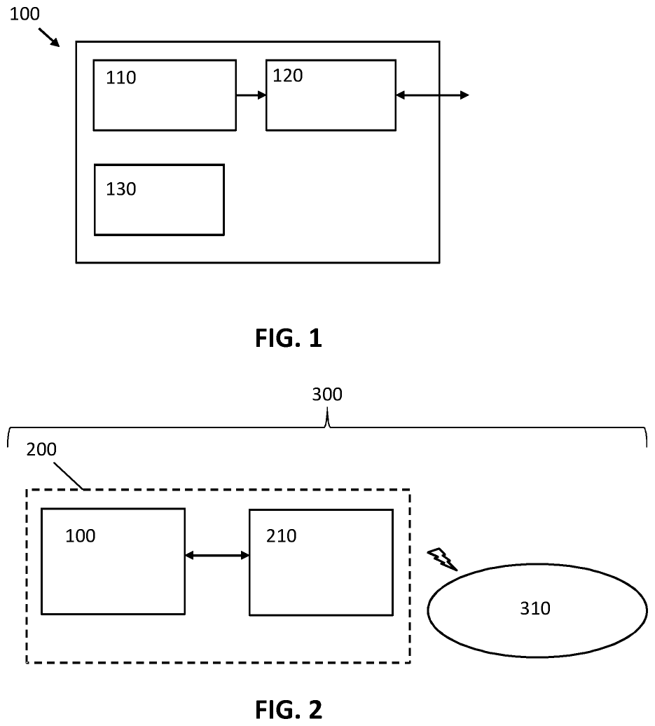

FIG. 1 schematically shows the basic building blocks of a glazing sensor 100 in accordance with embodiments of the present invention. The vibration sensor 110, the communication module 120 and the acceleration sensor 130 are shown. Additional building blocks may be present as will be discussed later in the description.

A glazing sensor 100, in accordance with embodiments of the present invention, can be mounted against the surface of an automotive glazing and can be used for monitoring structure-borne vibrations occurring in said glazing. These may be caused by an external event affecting the glazing such as an impact on the glazing or such as the friction of a worn glazing wiper (e.g. a windscreen wiper). In case of an external event, the analysis of the captured electrical signals, resulting from the vibration of the sensors in contact with the glazing, allows to determine the severity of the external event. This may for example lead to the conclusion whether or not the external event did damage the glass. In some embodiments of the present invention the glazing sensor comprises a plurality of vibration sensors 110. Such devices for example allow to determine the location of the external event, and/or they may be used to improve the measurement result.

The processing of the electrical signal may be done locally on the glazing sensor or it may be done remotely on another computing device, or part of the processing may be done locally and part of the processing may be done remotely.

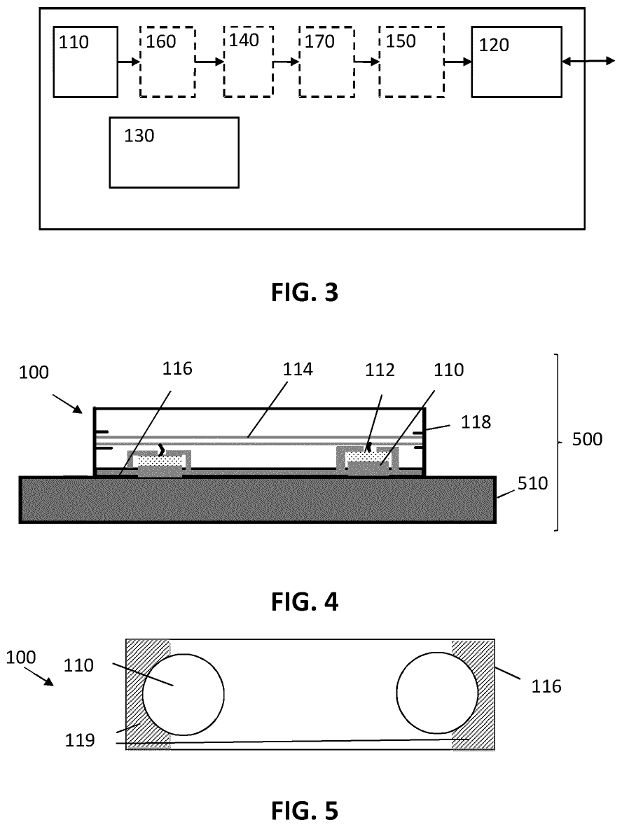

One or more pre-processing steps may be performed on the electrical signal before transmitting a signal comprising characteristic information of the electrical signal. FIG. 3 schematically shows different additional building blocks which may or may not be present in a glazing sensor in accordance with embodiments of the present invention. A filter and/or amplifier 160 may be present for filtering and/or amplifying the electrical signal of the vibration sensor 110. The electrical signal or the filtered and/or amplified electrical signal may be converted into a digital signal by an A/D converter 140. A digital filter 170 may filter the digital signal of the A/D converter. The glazing sensor may comprise a processing module 150 adapted for processing the digital signal before transmitting the processed signal with the communication module. The processing module 150 may for example be a microcontroller, a microprocessor, a field programmable gate array, etc. The communication module 120 is adapted for transmitting a signal comprising characteristic information of the electrical signal. It may for example receive this signal from the processing module 150.

The filter 160 may for example be a high pass filter which is applied to the electrical signal from the vibration sensor 110. This allows to eliminate the low frequency noise related to unwanted effects. In case the vehicle is a car, bus, or truck this noise may for example be engine noise, wheels and road noise, music, etc.

The additional building block 160 may be adapted for amplifying the electrical signal. This amplification may for example increase the signal level from tens or hundreds of millivolts to levels compatible with standard analog to digital conversion stages typically of 0 to 5V.

In embodiments of the present invention multiple amplifications may be applied to the same signal, thereby generating multiple copies of the same signal with different amplification levels. This allows to cope with the fact that the vibration sensor will sense signals with varying amplitudes depending on how far away the external event such as an impact occurred from the location of the sensors. With different gains applied to the signal, the chance is higher that at least one copy of the signal will at least be detected and not be clipped.

An additional building block may be adapted for applying an offset on the electrical signal so that both the positive and negative variations of the signal can be captured by an ADC (Analog to Digital Converter) that is aimed at working only with a positive signal. This offset may be applied before or after amplifying the electrical signal.

The processing module 150 may comprise a microcontroller mounted on an electronic board 114 to manage the functionalities on the electronic board. The microcontroller generally includes the A/D converter 140 that will turn the analog signal into a digital signal that can further be processed by the microcontroller and other electronic systems.

A glazing sensor in accordance with embodiments of the present invention may comprise a plurality of components and protocols (like LTE chips, Bluetooth chips, Sim card readers, antennas etc.) for communicating to an external control unit.

In embodiments of the present invention characteristic information of the electrical signal may be derived by introducing a threshold level. Such a threshold level allows to capture a relevant signal situation, the signal of the vibration sensor (or the vibration sensors) is (are) ignored when below the threshold level and different systems (amplifier, comparator, microcontroller, communication channels etc.) can be set to sleep mode to reduce power consumption. In embodiments of the present invention this may also be done when no acceleration is detected during a predetermined period of time.

When an acceleration is detected, the system is again put to active mode. When in active mode, several different thresholds may be used to determine whether the signal reaches certain levels. In a particular embodiment, two thresholds are used and form a “window” comparator. While the signal remains within the boundaries of the window, the system may continue to sleep. If the signal crosses any of the boundaries (i.e. become greater than the upper threshold or less than the lower threshold), the system will wake up and start capturing the signal.

In embodiments of the present invention, the threshold may be passed when an external event such as an impact occurs. Upon passing this threshold the different systems may be awaken. In embodiments of the present invention a record of all the sensors may be made for a given time, of about 50 ms, preferably 5 to 10 ms, after the external event. These signals are called the “traces”.

In embodiments of the present invention the electronic signals (e.g. the traces) can either be processed locally using a processing module (e.g. using a microcontroller on a PCB). An algorithm may be used to extract the characteristic information. Possible examples of characteristic information are: the external event (e.g. impact) occurrence, breaking or non-breaking external event, X and Y location of the external event/breakage. Typical algorithms may be used for training the recognition like support-vector machines (SVM), Random Forests, etc. The output is transmitted to the user and/or to a control system) using the communication module (e.g. by means of LTE, Bluetooth, etc.)

In another embodiment, the raw sensor signals, or only partially processed signals, are transmitted using the communication module (e.g. by means of LTE, Bluetooth, etc.) to another computing device (e.g. a storage and processing unit which may for example reside in the Cloud). In that case, the algorithm, or part of it, is executed at this computing device (e.g. storage and processing unit). The relevant information is then transferred to the user or to a control system. The advantage of such a system is that it is easier to update/improve the algorithm.

According to a second aspect embodiments of the present invention relate to a glazing package 200 comprising a glazing sensor 100 according to embodiments of the present invention and a gateway 210. The gateway 210 is adapted for receiving the signal from the communication module 120 and for relaying the received signal.

According to a third aspect embodiments of the present invention relate to a glazing system 300 comprising a glazing package 200 and a computing device 310 wherein the computing device 310 is adapted for receiving the relayed signal from the communication module 120 and for storing and processing the received signal.

A schematic drawing of a glazing package 200 and a glazing system 300 according to embodiments of the present invention is schematically illustrated in FIG. 2. In this example the glazing system 300 comprises three components:
the glazing sensor 100,
the computing device 310,
and the gateway 210.

The computing device 310 may be a server/cloud infrastructure, available on the Internet, that provides enough computation resources to analyze the data and provides storage for the data.

The gateway 210 is adapted to relay the signal from the communication module 120 (e.g. data) to the computing device 310. The gateway device 210 may therefore receive data from the communication module 210 via a wireless communication link such as a Bluetooth communication link. The gateway 210 typically has access to the internet, generally through a mobile communication module. It may transmit the data to the computing device 310 over a long range communication technology, or a cellular communication network, such as a GSM network, an EDGE network, a 3G network, or an LTE network.

In embodiments of the present invention the glazing package may be embedded in a car. The glazing sensor is thereby mounted at a border of the windscreen and the gateway is somewhere in the car. Both may be adapted to communicate together using a short range communication technology, such as for example Bluetooth low energy (BLE).

Although the gateway 210 may be embedded in the car, it could also be implemented in the form of an application on the smartphone of the driver. This distinction between a gateway 210 “attached” to the car or a “portable” gateway on smartphone is not relevant and has no impact on the behavior of the glazing package 200 as described.

In embodiments of the present invention the vibration sensor 110 may be a sensor adapted for measuring the vibration and/or acoustic signature of the glazing. This could be an accelerometer, a microphone or a piezo electric sensor. One example of a sensor may for example be a piezo-electric sensor from Murata (e.g. 7BB-20-6L0).

A schematic drawing of a glazing sensor 100 in accordance with embodiments of the present invention is shown in FIG. 4. The glazing sensor 100 comprises vibration sensors 110 and a foam 112 per sensor. The foam 112 is mounted in a bracket 116 such that when the bracket is mounted against the window (e.g. using double sided tape or using glue, or by any other means, the vibration sensor 110 is pushed on the glass by the foam 112, with some spring effect of the foam. Thereby a good contact between the vibration sensor 110 and the glass is ensured. The glazing sensor of FIG. 4 comprises an electronic board 114 (e.g. a PCB). The vibration sensor 110 is electrically connected to the electronic board 114. The electronic board 114 and the bracket 116 are mounted in a cover 118. The cover box or housing 118 may be designed such that they allow better integration in the car. The housing 118 may for example be made of plastic/composite material. The cover box 118 may include some holes to evacuate heat. The cover box 118 may also include holes equipped with light pipes, allowing some LED's on the PCB to provide visual indication of the activity or status of the PCB. The cover box 118 may for example be attached to the electronic board 114 through mechanical means (bolts, glue . . . ) or for example through magnetic means.

FIG. 5 shows a schematic drawing of the bottom view of a glazing sensor 100 in accordance with embodiments of the present invention. It shows the bracket 116 with mounted therein the vibration sensors 110. In the example of FIG. 5 adhesive tape 119 is glued on the bracket 116. Different materials may be used to fix the glazing sensor and its one or more vibration sensors to the glass. In one embodiment double sided adhesive tape or pressure sensitive double sided tape or repositionable double sided tape can be used. The lower adhesion side may allow multiple installations/desinstallations of the device. This lower adhesion side thereby is the side which is in contact with the glass when the glazing sensor is installed. It may be selected in order not to deteriorate the performance of the sensor. It can potentially be replaced if it wears. This tape may be chosen to be resistant to temperatures higher than 70° C., ideally up to 120° C. and resistant to UV light. Examples of such tapes are available by company 3M.

The tape may cover the whole surface of the back of the housing but, in one particular embodiment, the tape is located only on the sides of the back the housing, for example on a 1 cm wide area between the edges of the vibration sensors and the edges of the housing (see FIG. 5). This allows for an easier removal of the device from the glass. In another embodiment the low adhesion side of the tape can be replaced by microsuction tape, the other side being a classical adhesive tape. This allows multiple installations/desinstallations of the device.

In embodiments of the present invention the glazing sensor 100 may comprise a single vibration sensor 110. Such a glazing sensor may also be referred to as a mono sensor device. In embodiments of the present invention the mono-sensor device may be adapted for detecting an external event (e.g. impact) and discriminating a breakage/non breakage situation. It's advantage is its small size. In a preferred embodiment, the monosensor module size is between 1 cm×1 cm up to 6 cm×6 cm or has a circle diameter between 1 to 6 cm.

In another embodiment of the present invention the glazing sensor 100 comprises 2 vibration sensors 110. Such a glazing sensor 100 may also be referred to as a bi-sensor device. A bi-sensor device according to embodiments of the present invention may be adapted for detecting an external event (e.g. impact) and discriminating a breakage/non breakage situation. A bi-sensor device according to embodiments of the present invention may also be adapted for estimating the location of the external event (e.g. impact) on the glazing. This may for example be achieved by auto-correlating the signals from both vibration sensors to obtain the delay between both signals or for example using a machine learning model. The bi-sensor device may be adapted for indicating whether the external event was on the left or right side of the glazing (e.g. windshield). A bi-sensor device in accordance with embodiments of the present invention may for example have a size around 3 cm×11 cm. The device may even be wider. It is thereby advantageous that by increasing the spacing between the vibration sensors, a more accurate determination of the location of the external event can be achieved. The device may also be higher. It is thereby advantageous that larger sensors can be used.

In some embodiments of the present invention a glazing sensor 100 may comprise more than 2 vibration sensors. For example 3 to 10, or more preferably 3 to 6 vibration sensors 110 may be present in one glazing sensor. A glazing sensor may for example comprise 4 vibration sensors. Such a multisensor device in accordance with embodiments of the present invention may be adapted for detecting an external event, and/or for discriminating a breakage/non breakage situation. A multisensor device according to embodiments of the present invention may be adapted for more accurately estimating the location of the external event on the glazing. For example the X position (the horizontal position on the glazing) may be more accurately estimated than in case only one or two vibration sensors are used. In embodiments of the present invention the different vibration sensors may be placed on separate PCBs or on the same PCB. A glazing sensor in accordance with embodiments of the present invention may be connected with other sensors using a wired or wireless connection.

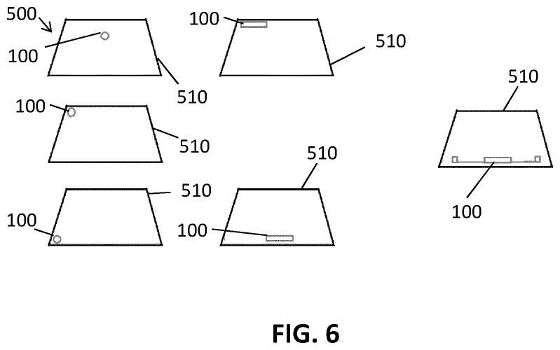

The glazing sensor 100 is mounted against the glazing 510, thus an automotive glazing 500, according to a fourth aspect of the present invention, is obtained. In FIG. 6 different configurations of automotive glazing 500 in accordance with embodiments of the present invention are illustrated. In this example the glazing is a windscreen of a car. The invention is, however, not limited thereto. Also glazing for any other type of vehicles such as busses, trucks, trains, airplanes, boats is possible. The glazing sensors 100 are installed on the glazing on the internal surface inside the car to protect it from a harsh environment, in a position on the windshield where they affect as little as possible the driver's field of view. Preferably the top or bottom position of the windshield is selected. Different possible locations are illustrated in FIG. 6. The glazing sensors may be mono-sensors (in the figure represented by the circles), bi-sensors (in the figure represented by the rectangles) and multi-sensors (in the figure represented by the rectangle connected with two circles). One or more glazing sensors may be present, and a glazing sensor may be connected with one or more peripheral sensors. These glazing sensors and the peripheral sensors may be arranged outside the field of view of the driver.

1: A glazing sensor for detecting vibration of an automotive glazing, the glazing sensor comprising at least one vibration sensor, and a communication module,
wherein the vibration sensor is configured to convert a vibration of the automotive glazing into an electrical signal, and
wherein the communication module is configured to transmit a signal comprising characteristic information of the electrical signal, the glazing sensor further comprises an acceleration sensor, the glazing sensor is configured to put itself in sleep mode when no acceleration is detected during a predetermined period of time, and put itself in active mode when an acceleration is detected,
wherein the functionality of the glazing sensor is reduced in sleep mode compared to the functionality in active mode.

2: The glazing sensor according to claim 1, wherein the glazing sensor is configured to read out the acceleration sensor at regular intervals and put the glazing sensor in sleep mode if no acceleration is detected during a predetermined number of intervals.

3: The glazing sensor according to claim 1, wherein the glazing sensor is configured to receive an interrupt from the acceleration sensor for detecting an acceleration.

4: The glazing sensor according to claim 1, wherein the glazing sensor is configured to manage power consumption of at least one electronic component of the glazing sensor.

5: The glazing sensor according to claim 1, wherein the vibration sensor is a piezoelectric sensor.

6: The glazing sensor according to claim 1, wherein the glazing sensor further comprises an analog to digital converter for converting the electrical signal from the vibration sensor into a digital signal.

7: The glazing sensor according to claim 6, wherein the glazing sensor further comprises a processing module configured to process the digital signal before transmitting the processed signal with the communication module.

8: The glazing sensor according to claim 7, wherein the processing module is configured to compare a predefined signature with the digital signal, or wherein the processing module may use a machine learning model for obtaining characteristic information of the electrical signal.

9: The glazing sensor according claim 1, wherein the glazing sensor comprises at least two vibration sensors.

10: The glazing sensor according to claim 1, wherein the communication module is configured to for wirelessly transmit a signal comprising the characteristic information of the electrical signal.

11: A glazing package comprising the glazing sensor according to claim 1 a gateway, wherein the gateway is configured to receive characteristic information of the electrical signal from the communication module and relay the received characteristic information.

12: The glazing package according to claim 11, further comprising a computing device wherein the computing device is configured to receive the relayed characteristic information of the electrical signal and store and process the received characteristic information of the electrical signal.

13: An automotive glazing comprising the glazing sensor according to claim 1, wherein the glazing sensor is mounted at a border of the automotive glazing.

14: The automotive glazing according to claim 13, wherein the automotive glazing is mounted in a vehicle, and wherein the glazing sensor is mounted on the glazing at the inside of the vehicle.

15: The automotive glazing according to claim 13, wherein the automotive glazing is mounted in a vehicle, and wherein the glazing sensor is mounted on the glazing at the outside of the vehicle under a hood of the vehicle.
